(19) United States
(12) Patent Application Publication
(10) Pub. No.: US 2013/0271827 A1
(43) Pub. Date: Oct. 17, 2013

(54) INDEXING OPTICS FOR AN ACTINIC EXTREME ULTRA-VIOLET (EUV) RETICLE INSPECTION TOOL

(71) Applicant: KLA-TENCOR CORPORATION, Milpitas, CA (US)

(72) Inventors: Gildardo Delgado, Livermore, CA (US); Frank Chilese, San Ramon, CA (US)

(73) Assignee: KLA-Tencor Corporation, Milpitas, CA (US)

(21) Appl. No.: 13/860,377

(22) Filed: Apr. 10, 2013

Related U.S. Application Data
(60) Provisional application No. 61/623,564, filed on Apr. 13, 2012.

(51) Int. Cl. G02B 5/20; G02B 27/00

(52) U.S. Cl. CPC G02B 5/208; G02B 27/0006
USPC 359/361; 359/350

(57) ABSTRACT

A method for reducing damage and contamination to an optical element in an extreme ultra-violet (EUV) reticle inspection system, including, presenting an illumination source to a reticle inspection system, and displacing the optical element in the path of the illumination source from a first portion to a second portion, wherein the first portion is damaged and the second portion is not damaged, and the optical element has a plurality of portions.

### CROSS-REFERENCE TO RELATED APPLICATIONS

This application claims the benefit under 35 U.S.C. § 119(e) of U.S. Provisional Application No. 61/623,564, filed Apr. 13, 2012, which application is incorporated herein by reference.

### FIELD OF THE INVENTION

The present invention broadly relates to reticle inspection tools, and, more particularly, to indexing optics for reticle inspection, and, even more particularly, to a displaceable optical element arranged to move within a light path to prolong the useful life of the element or tool.

### BACKGROUND OF THE INVENTION

Conventional apparatus in the market for reticle inspection generally employ deep ultra-violet (DUV) wavelengths at 193 nanometer (nm) operating in air. This is suitable for masks designed for use in lithography based on 193 nm light. Known DUV reticle inspection tools operate in air, not a vacuum. To further improve the printing of minimum feature sizes, next generation lithographic equipment is now designed for operation with wavelengths of approximately 13.5 nm, also known as extreme ultra-violet (EUV). Accordingly, patterned masks designed for operation near 13 nm must be inspected using a similar wavelength of light.

Optical elements within an EUV reticle inspection tool that absorb light from an illumination source become damaged or contaminated over time. Damage and contamination occur from EUV or ultra-violet (UV) energy absorbed into the optical element coatings, heating at a spot inducing thermal damage, photo-initiated chemical contamination darkening, or photo-initiated chemical oxidation on a spot on a surface of the optical element. Transmissive films, e.g., spectral purity filters (SPFs), detectors, and sensors are used as optical elements within such tools. These films are extremely thin and prone to mechanical damage at the spot where the EUV light passes through or reflects. Repeated exposure to EUV light increases damage or contamination to the optical elements. This damage or contamination decreases the useful life of the optical element and increases the frequency of service repairs on the inspection tool.

Traditionally, optical elements are cleaned in position after the inspection tool is opened, which eliminates the vacuum within the tool. Alternatively, the optical element is replaced. In-position cleaning requires complex mechanisms that pose a risk to the inspection tool. For example, using a heated filament to create atomic hydrogen for cleaning leaves the filament exposed for breakage, which could damage the inspection tool. Manual cleaning requires significant downtime of the inspection tool. The tool is vented, manual cleaning is performed, and the tool is re-evacuated to create a vacuum inside the tool. Manual cleaning also poses risk to elements in close proximity to the cleaning Replacing the damaged optical elements requires the same tool downtime as manually cleaning the elements. However, the expense of replacing the damaged optical element adds to the cost and downtime of the inspection tool.

Thus, there is a long-felt need for a system to improve upon the shortcomings of current optical elements inside reticle inspection tools, i.e., to further improve the life of optical elements thereby minimizing inspection tool downtime.

### SUMMARY OF THE INVENTION

The present invention broadly comprises a method for reducing damage and contamination to an optical element in an EUV reticle inspection system by presenting an illumination source to a reticle inspection system and displacing the optical element in a path of the illumination source from a first portion to a second portion, where the first portion is damaged and the second portion is not damaged. The optical element includes a plurality of portions.

Furthermore, the present invention broadly comprises a method for reducing damage and contamination to an optical element in an EUV reticle inspection system, including, providing an EUV illumination source, transmitting a light beam from the EUV illumination source to a first portion on the optical element, and displacing the optical element whereby the light beam transmits to a second portion on the optical element.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a diagram of a circular optical element; and,

FIG. 2 is a diagram of a rectangular optical element.

### DETAILED DESCRIPTION OF THE INVENTION

At the outset, it should be appreciated that like drawing numbers on different drawing views identify identical, or functionally similar, structural elements of the invention. It also should be appreciated that figure proportions and angles are not always to scale in order to clearly portray the attributes of the present invention.

While the present invention is described with respect to what is presently considered to be the preferred aspects, it is to be understood that the invention as claimed is not limited to the disclosed aspects. The present invention is intended to cover various modifications and equivalent arrangements included within the spirit and scope of the appended claims.

Furthermore, it is understood that this invention is not limited to the particular methodology, materials and modifications described and, as such, may, of course, vary. It is also understood that the terminology used herein is for the purpose of describing particular aspects only, and is not intended to limit the scope of the present invention, which is limited only by the appended claims.

Although any methods, devices or materials similar or equivalent to those described herein can be used in the practice or testing of the invention, the preferred methods, devices, and materials are now described.

High volume manufacturing of semiconductors requires high powered illumination sources. These types of illumination sources create a high intensity light beam that can damage optical elements within an inspection tool. The introduction of a displaceable optical element, as described herein, provides decreased inspection tool maintenance by displacing the optical element within the illumination beam from a damaged or contaminated portion to a new, undamaged portion, or from one optical element to an identical replacement element moved in from a position not in the optical beam path. The present invention, a displaceable optical element, is used in a reticle inspection tool. Accordingly, a general description of reticle inspection tools is provided to better understand the use of a displaceable optical element within a reticle inspection tool.

An actinic EUV reticle inspection tool allows for inspection at EUV wavelengths without the large size and particulate addition problems encountered by other EUV lithography tools. The actinic EUV reticle inspection tool may include multiple EUV sources as an illumination source for the inspection tool.

Once the light beam is generated from the EUV source(s) the light beam follows a specific path inside the inspection tool. The light beam emitted from the EUV source(s) travels to collector optics designed to redirect the light towards the illumination and imaging optics. The light beam images the patterned surface of the reticle and travels through the optical configuration into time delay integration (TDI) sensors.

EUV energy is a highly absorbed component of the electromagnetic spectrum. For example, the transmission of EUV light must occur in a vacuum to allow the EUV beam to propagate. Accordingly, the internal space of the actinic EUV reticle inspection tool operates in a vacuum to allow for the proper transmission of EUV light.

The reticle's patterned surface is very sensitive to the introduction of particulates. A pellicle, which is an ultra-thin, ultra-lightweight semi-transparent mirror employed in the light path of an optical instrument, may not be able to be used at EUV wavelengths. Since a pellicle might not be used, multiple protection mechanisms may be utilized to protect the patterned surface from particulates.

The actinic EUV reticle inspection tool utilizes a plurality of TDI sensors to improve the signal to noise ratio (SNR) of processed pattern images. Each TDI is held in a fixed pattern on the inspection tool and positioned based on the reticle and the optical configuration required.

One of ordinary skill in the art will appreciate that the forgoing considerations and components related to an actinic EUV reticle inspection system will result in a variety of types of elements that must be accommodated. The surfaces of optical elements within the actinic EUV reticle inspection tool become damaged or contaminated over time from absorbed EUV or ultra-violet (UV) energy. Servicing the inspection tool to repair a damaged portion of an optical element is costly and time consuming. Servicing includes repair or replacement of the optical element damaged from the illumination source. In accordance with the present invention, moving an optical element from a damaged portion or element to an undamaged portion or element increases the life of the optical element and reduces the need for invasive service to the inspection tool. In an example embodiment, the multiple optical elements can be substantially similar to each other. Substantially similar means the optical elements are identical or within a performance tolerance capable of replacing each other in an optical path.

In some embodiments, a protective covering in the form of a moving aperture shield is positioned on an undamaged portion or element that will move into the space of a damaged portion or element. The moving aperture shield allows the primary portion or element to receive power but protects the alternate portions or elements from being damaged. Cycling through numerous portions or elements significantly increases the life of the optical element.

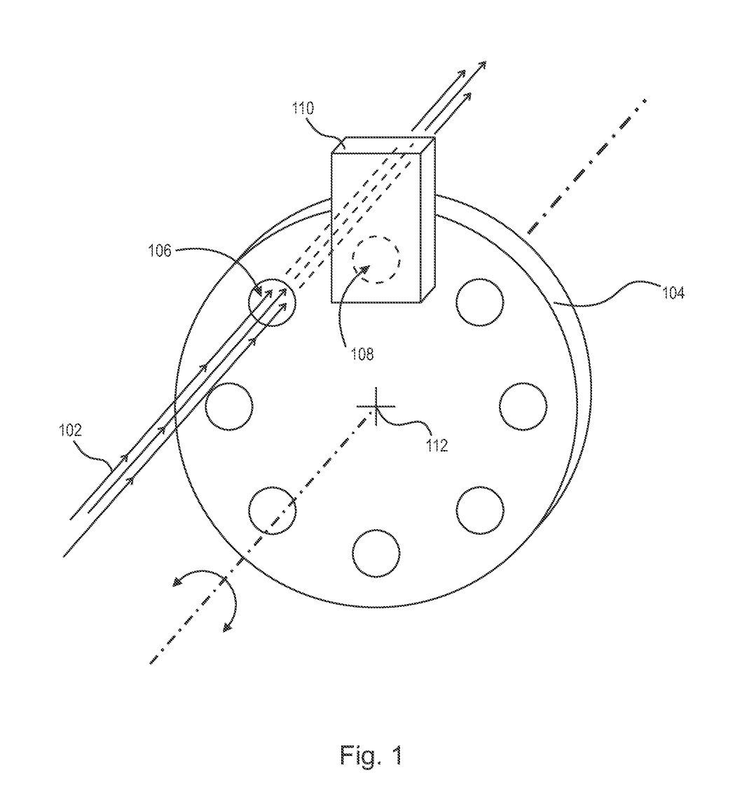

In an embodiment, e.g., the embodiment shown in FIG. 1, an optical element is configured to be displaced relative to an illumination beam. The present invention, a method for reducing damage to optics in an extreme ultra-violet (EUV) reticle inspection system, includes presenting illumination source 102 to a reticle inspection system and displacing optical element 104 in the path of illumination source 102 from first portion 106 to second portion 108, wherein first portion 106 is damaged and second portion 108 is not damaged and optical element 104 comprises a plurality of portions, depicted by broken line circles. The optical element is located within the path of the illumination source of the reticle inspection tool. After continued usage, first portion 106 on optical element 104 where light passes through and/or reflects becomes damaged from the energy of the EUV illumination source. The present invention provides a method for displacing the optical element from a damaged portion to allow light to pass through and/or reflect using a new, undamaged portion on the optical element. The optical element contains a plurality of portions which provide a longer life and less lost time repairing or replacing the optical element inside the reticle inspection tool. It is understood that the light used with the present invention may travel through, reflect, or do a combination of both depending on the composition of the optical element.

In an example embodiment, first portion 106 and second portion 108 are located at different portions on optical element 104. Light from illumination source 102 passes through or reflects off of first portion 106 during usage of the EUV inspection tool. Due to the intensity of the illumination source, the first portion on the optical element becomes damaged over time. Typically, the optical element is repaired or replaced once damaged. The present invention provides a method to displace the optical element so the damaged portion, i.e., first portion 106, is moved out of the light path and a new portion, i.e., second portion 108, is placed into the light path. In an example embodiment, optical element 104 is an assembly of small SPFs located on a rotary stage.

In an example embodiment, the optical element uses shield 110 to block the illumination of second portion 108 when first portion 106 is illuminated. Shield 110 protects second portion 108 from damage while the light passes through or reflects off of first portion 106. Shield 110 protects at least one portion on optical element 104. The shield can also be sized to protect a plurality of portions on the optical element, not just one portion. In an example embodiment, shield 110 is displaceable to allow illumination of second portion 108. The shield can rotate or shift in a translational direction to expose the second portion. In an alternative embodiment, the optical element displaces relative to the shield. The shield is affixed to the rotary stage or other component of the inspection tool.

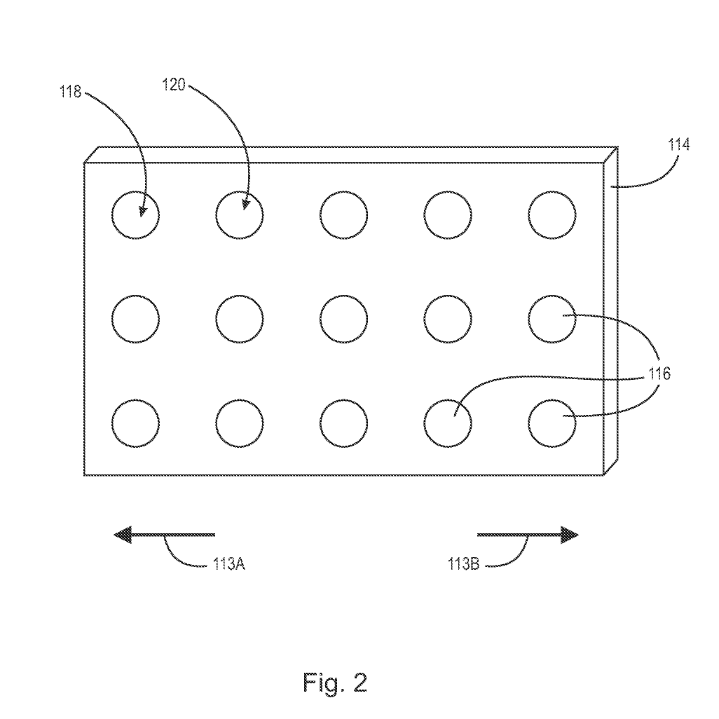

In an example embodiment, optical element 104 displaces by translational movement, rotational movement, or translational and rotational movement. Rotational movement is when an object, such as an optical element, turns about an axis. For rotational movement of the present invention, the optical element comprises a series of portions, e.g., spots shown in FIG. 1, located towards the outer edge of the optical element. When first portion 106 is damaged, optical element rotates about axis 112 to move first portion 106 out of the light beam. Optical element 104 is held in place by a rotary stage. After rotational movement of optical element 104 is complete about axis 112, second portion 108 is in the light beam. Translational movement is when an object, such as an optical element, is displaced without a change in orientation relative to a fixed point. Translation may occur on a straight line, curved path, or sporadic path. Whichever path the object moves, the object orientation remains unchanged relative to a fixed point. For translational movement of the present invention, depicted in FIG. 2 with bi-directional arrows 113a and 113b, optical element 114 has a generally rectangular shape with a plurality of portions 116 oriented horizontally, vertically, linearly, or a combination thereof. When a portion is damaged, optical element 114 displaces in a translational direction to move the damaged portion out of the light beam. When displacement is complete, a new, undamaged portion from plurality of portions 116 is in the light beam. Optical elements 114 are mounted with sufficient rigidity to provide accurate rotational or translational repositioning and enable tool functioning. When first portion 118 is detected as damaged, optical element 114 indexes to a new position thereby placing second portion 120 into the light beam. The life of the optical element is increased by the number of usable portions on the optical element.

In an example embodiment, first portion 106 and second portion 108 are each located on first and second optical elements, respectively. Instead of having a plurality of portions on one optical element, multiple optical elements are used. An additional optical element has a plurality of portions, thereby increasing the overall tool life by maximizing the amount of time necessary between repairs or replacement of the optical element. Further, an example embodiment provides for translational movement, rotational movement, or translational and rotational movement of the first and second optical elements of the reticle inspection tool. After the plurality of portions on a first optical element are damaged by the light or photo induced contamination, a second optical element with undamaged portions moves into alignment with the light beam by rotational and/or translational displacement.

In an example embodiment, the optical element moves to a different region once damaged or contaminated. When the damaged or contaminated optical element moves to a new region, it is cleaned by a cleaning gas, plasma source, or other non-limiting example. This allows the damaged or contaminated portion to be cleaned and used again without the tool downtime required for replacing the optical element. By moving the optical element to a different region for cleaning, the optical element is replaced less frequently. This provides less down time to the inspection tool. Moreover, the optical elements will not be exposed to particulates during venting or to the environment.

In an example embodiment, illumination source 102 is UV light or EUV light. EUV light damages the optical element at the portion where the light beam passes through or reflects from it. Accordingly, the use of an optical element with a plurality of portions provides a longer lifespan for an EUV reticle inspection tool.

In an example embodiment, a method for reducing damage and contamination to an optical element in an extreme ultra-violet (EUV) reticle inspection system includes providing an EUV illumination source, transmitting a light beam from the EUV illumination source to first portion 106 on optical element 104, and displacing optical element 104 to whereby the light beam transmits to second portion 108. EUV light shines through or reflects off of a first portion on the optical element until repeated light exposure causes the first portion to become damaged. Once this occurs, the optical element displaces through rotational and/or translational movement to bring the second portion into the path of the illumination source. The second portion is an undamaged portion of the optical element since it was not in the path of the illumination source. Shield 110 can also be included to further protect the second portion from exposure to the illumination source.

Non-limiting examples of optical element 104 include a mirror, aperture, sensor (diodes), detectors (CCD's), filter, grating, and other non-limiting examples. The optical element is located in the light beam of a reticle inspection tool. In an example embodiment, the optical element is placed near an illumination source to allow collection of more contaminated light and to reduce the chance of particulates collecting on the optics inside the inspection tool.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. A method for reducing damage or contamination to an optical element in an extreme ultra-violet (EUV) reticle inspection system, comprising:
presenting an EUV illumination source to a reticle inspection system; and, displacing the optical element in the path of the EUV illumination source from a first portion to a second portion, wherein:
the first portion is damaged or contaminated and the second portion is not damaged or contaminated; and,
the optical element comprises a plurality of portions.

2. The method recited in claim 1, wherein the first and second portions are different portions on the optical element.

3. The method recited in claim 2, further comprising a shield to block illumination of the second portion when the first portion is illuminated.

4. The method recited in claim 3, wherein the shield is displaceable to allow illumination of the second portion.

5. The method recited in claim 3, wherein the shield is a spectral purity filer (SPF).

6. The method recited in claim 1, wherein displacing the optical element is achieved by translational movement, rotational movement, or translational and rotational movement.

7. The method recited in claim 1, wherein the illumination source is an EUV light.

8. The method recited in claim 1, wherein the first and second portions are located on first and second optical elements, respectively.

9. The method recited in claim 8, wherein each of the first and second optical elements is displaced by translational movement, rotational movement, or translational and rotational movement.

10. The method recited in claim 8, wherein the first and second optical elements are substantially similar.

11. The method recited in claim 1, wherein the optical element is a mirror, an aperture, a sensor, a detector, a filter, or a grating.

12. The method recited in claim 1, wherein the optical element displaces to a cleaning region to position the damaged or contaminated first portion for cleaning

13. A method for reducing damage and contamination to an optical element in an extreme ultra-violet (EUV) reticle inspection system, comprising:
providing an EUV illumination source;
transmitting a light beam from the EUV illumination source to a first portion on the optical element; and,
displacing the optical element whereby the light beam transmits to a second portion on the optical element.

14. The method recited in claim 13, wherein the illumination source is an EUV light.

15. The method recited in claim 13, further comprising using a shield to block illumination of the second portion when the first portion is illuminated.

16. The method recited in claim 15, wherein the shield is displaceable to allow illumination of the second portion.

17. The method recited in claim 15, wherein the shield is a spectral purity filer (SPF).

18. The method recited in claim 13, wherein displacing the optical element is achieved by translational movement, rotational movement, or translational and rotational movement.

19. The method recited in claim 13, wherein the first and second portions are located on first and second optical elements, respectively.

20. The method recited in claim 19, wherein each of the first and second optical elements is displaced by translational movement, rotational movement, or translational and rotational movement.

21. The method recited in claim 19, wherein the first and second optical elements are substantially similar.

22. The method recited in claim 13, wherein the optical element is a mirror, an aperture, a sensor, a detector, a filter or a grating.

23. The method recited in claim 13, wherein the optical element displaces to a cleaning region to position the damaged or contaminated first portion for cleaning.
